(19) United States
(12) Patent Application Publication
(10) Pub. No.: US 2012/0206252 A1
(43) Pub. Date: Aug. 16, 2012

(54) LANE DEPARTURE WARNING SYSTEM

(75) Inventors: Rini Sherony, Ann Arbor, MI (US); Hideki Hada, Ann Arbor, MI (US)

(73) Assignee: TOYOTA MOTOR ENGINEERING & MANUFACTURING NORTH AMERICA, INC., Erlanger, KY (US)

(21) Appl. No.: 13/029,078

(22) Filed: Feb. 16, 2011

(51) Int. Cl. B60Q 1/00

(52) U.S. Cl. 340/438

(57) ABSTRACT

Devices, methods and systems are disclosed herein to describe a lane departure warning system that warns the driver that the vehicle is about to leave a current lane and enter an adjacent lane. The driver of the vehicle is identified, and a corresponding profile is accessed. The driver's pupils may be measured and compared to pupil size data stored in the accessed profile. If the difference in pupil size exceeds a certain threshold, then the vehicle may activate a passive lane departure detector that warns the driver each time the vehicle is getting too close to an adjacent lane, thus alerting the driver that the vehicle may be unintentionally drifting into the next lane. Additional driving tendencies, such as steering angles and braking force, may also be used to determine whether the driver may benefit from lane departure assistance and whether to trigger activation of the lane departure detector.

### BACKGROUND

1. Field

The present invention describes methods, devices, and/or systems related to lane departure warning systems. For example, a lane departure warning system may warn a driver that the vehicle may be on the verge of leaving the current lane of a road and entering an adjacent lane of the road.

2. Description of Related Art

Various systems are being developed to prevent people from driving under the influence of alcohol. For example, some automobile manufacturers are currently exploring the possibility of integrating a breathalyzer test into the vehicle which a driver must pass in order to start the engine. However, such active deterrent systems may be further supplemented and/or replaced by other systems.

### SUMMARY

This Summary is included to introduce, in an abbreviated form, various topics to be elaborated upon below in the Detailed Description. This Summary is not intended to identify key or essential aspects of the claimed invention. This Summary is similarly not intended for use as an aid in determining the scope of the claims.

Devices, systems, and methods discussed herein relate to a lane departure warning system that warns the driver when the vehicle is beginning to drift towards the lane markers (i.e., to guard against unintentionally drifting out of the current lane and into an adjacent lane). As used herein, intoxication or intoxicated, whether used in connection with impairment or not, is defined to include any type of impairment (e.g., resulting from alcohol, drugs, and/or other substances) and may further cover other situations where the driver is not legally impaired but assistance to the driver may be desirable nonetheless. For example, in an exercise of caution and to promote safety, intoxication of a driver may include situations where the driver is deemed by the system 200 to be impaired even if the driver is well below legally allowable thresholds. Moreover, the concepts described herein may further be applicable to determine if a driver's driving habits deviate too much from normal driving habits, thus suggesting, for example, that the driver is falling asleep, is extremely tired or fatigued, is a new driver, is a careless or reckless driver, is too distracted (e.g., talking on the phone or texting on the phone) or is otherwise not paying enough attention to operating the motor vehicle.

In one embodiment, a lane departure warning system may determine if the driver may benefit from lane departure assistance (e.g., intoxicated, impaired, or distracted). If the driver is deemed to be in need of assistance, a lane departure detector (a subsystem of the lane departure warning system) may be activated to warn the driver each time the vehicle moves too close to the lane marker, as studies have shown that accidents may be reduced if the driver is warned before unintentionally entering into an adjacent lane.

In one embodiment, the driver of the vehicle is identified, and a corresponding profile is accessed. The driver's pupils may be measured and compared to pupil size data stored in the accessed profile. If the difference in pupil size exceeds a certain threshold, then the vehicle may activate a passive lane departure detector that warns the driver each time the vehicle is getting too close to an adjacent lane, thus alerting the driver that the vehicle may be unintentionally drifting into the next lane. Additional driving tendencies, such as steering angles and braking force, may also be used to determine whether the driver may benefit from lane departure assistance and whether to trigger activation of the lane departure detector.

In one embodiment, if the driver of the vehicle is not identified, the driver may be prompted to create a profile. For example, the driver may be requested to drive for a certain time period to allow the vehicle system to gather data on steering behavior, braking tendencies, and the like. In addition, the gathered data may include measuring one or both pupils of the driver's eyes. Even after the initial profile is complete, the system may update the profile by continuing to gather more data regarding the driver's driving patterns, which may improve the system's ability to more accurately respond to changes in the driver's normal operating tendencies. In one embodiment, the profile may be used to determine whether the driver may benefit from lane departure assistance.

In one embodiment, the vehicle may receive data from a sensor or a camera directed to lane markers of a lane in which the vehicle is traveling. The data may be used to help determine whether the vehicle is starting to drift too close to the lane marker or is about to cross into an adjacent lane unintentionally. If the vehicle system ascertains that the vehicle is too close to the lane marker or is crossing the lane marker, a warning message may be outputted audibly and/or visually to the driver.

### BRIEF DESCRIPTION OF THE DRAWINGS

The features, obstacles, and advantages of the present invention will become more apparent from the detailed description set forth below when taken in conjunction with the drawings, wherein:

FIG. 1A illustrates a vehicle with a pupil sensor or a camera according to one or more embodiments described herein;

FIG. 1B illustrates a vehicle on a multi-lane road with a lane-marker sensor and/or camera according to one or more embodiments described herein;

FIG. 1C illustrates a vehicle with both a pupil sensor and/or a camera and a lane-marker sensor and/or a camera according to one or more embodiments described herein;

FIG. 2A illustrates a block diagram of a vehicle system including a pupil sensor and/or a camera and a lane-marker sensor and/or a camera according to one or more embodiments described herein;

FIG. 2B illustrates a block diagram of a vehicle control unit according to one or more embodiments described herein;

FIG. 3 illustrates a flow chart of a lane departure warning system according to one or more embodiments described herein;

FIG. 4 illustrates a flow chart of a profile creation process related to a lane departure warning system according to one or more embodiments described herein;

FIG. 5 illustrates a flow chart of an intoxication determination process as related to a lane departure warning system according to one or more embodiments described herein;

FIG. 6 illustrates a flow chart of an operation of a lane departure detector as related to a lane departure warning system according to one or more embodiments described herein; and

FIG. 7 illustrates a visual display and an audio warning as related to a lane departure warning system according to one or more embodiments described herein.

### DETAILED DESCRIPTION

Apparatus, systems, and/or methods that implement the embodiments of the various features of the present invention will now be described with reference to the drawings. The drawings and the associated descriptions are provided to illustrate some embodiments of the present invention and not to limit the scope of the present invention. Throughout the drawings, reference numbers are re-used to indicate correspondence between referenced elements.

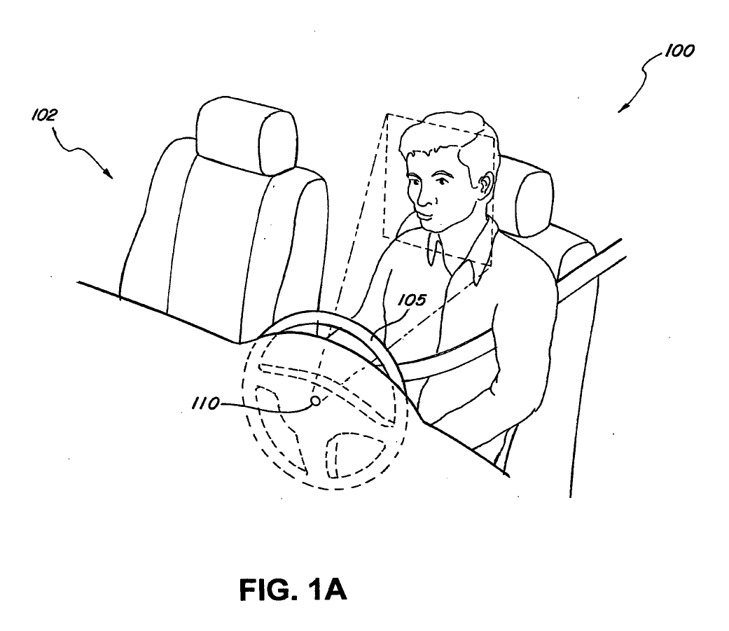

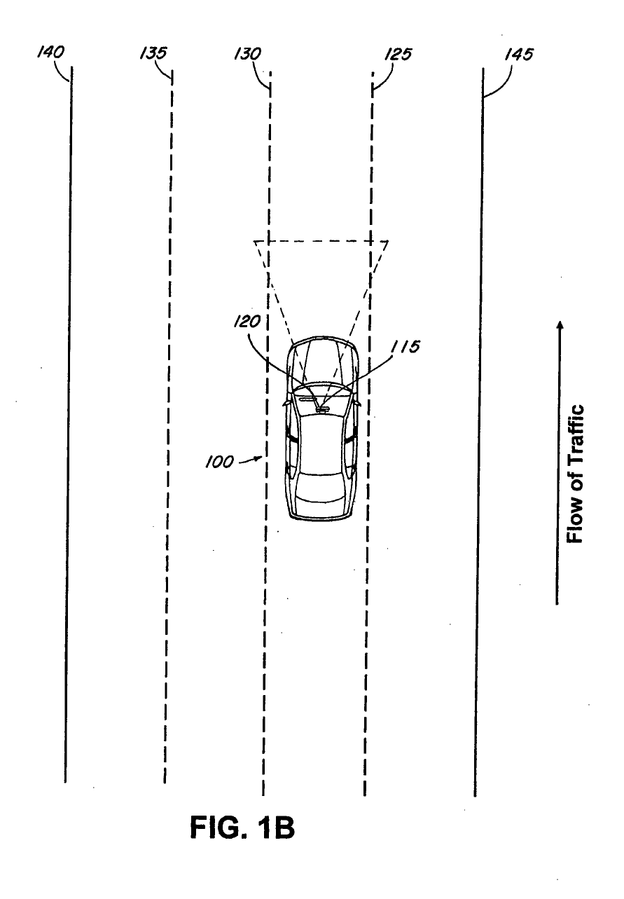

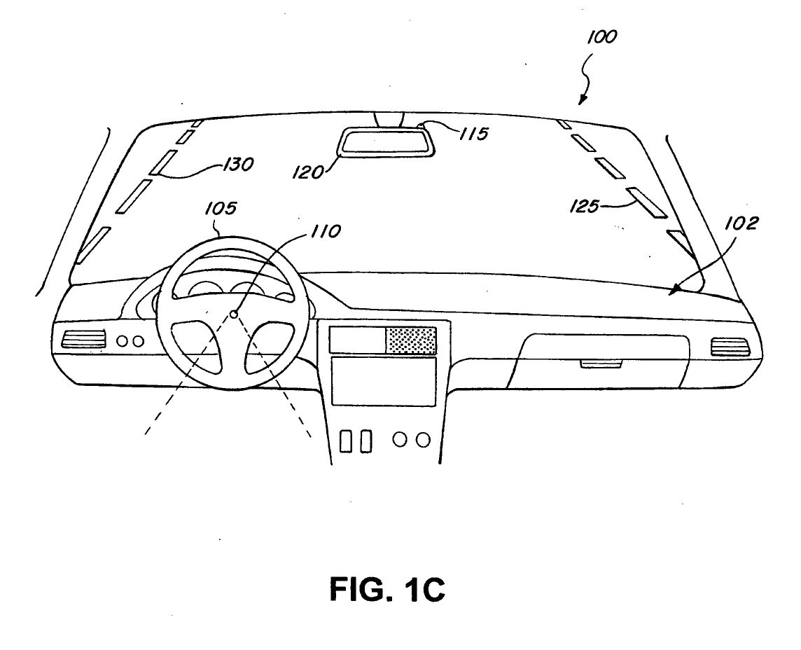

Turning to FIG. 1A, an interior 102 of a vehicle 100 is shown with a person in the driver's seat. In one embodiment, the vehicle interior 102 may include a steering wheel 105 with a camera 110 or other device configured to determine pupil size. Here, the camera 110 is shown mounted on the steering wheel 105 at a location such as the center. However, the camera 110 may be located anywhere that allows the camera 110 to obtain images of the driver's eyes, and more particularly, the pupils. For example, the camera 110 may be located on the instrument panel of the vehicle interior 102 (e.g., next to the fuel gauges), on the center control panel of the vehicle interior 102 (e.g., near radio/CD player controls), or on the frame or windshield of the vehicle interior 102. While shown as a single camera, the camera 110 may include, in one embodiment, multiple cameras, wherein one or more cameras can focus on a respective eye of the driver.

In one embodiment, four cameras may be used, with two cameras focused on each eye (not shown). Here, a first set of cameras may be located at one location (e.g., steering wheel) and a second set of cameras may be located at a second location (e.g., windshield). The first set of cameras may include at least two cameras, where a first camera is directed to the right eye of the driver and the second camera is directed to the left eye of the driver. Within the second set of cameras, a first camera may be directed to the right eye of the driver and a second camera may be directed to the left eye of the driver. By utilizing multiple cameras, a more accurate determination of the driver's pupil size may be obtained.

Methods of detecting a person's eye and taking images of the eye using a camera (e.g., by using camera 110) are known and any of these methods may be used to obtain images of the driver's eye for measuring the diameter and/or size of the pupil. In one embodiment, the camera 110 may include a wireless transmitter which is configured to transmit image data to a vehicle's control unit via, for example, BLUETOOTH. In another embodiment, the camera 110 may send and receive data from the vehicle's control unit via a hard-wired cable line coupled to the vehicle's controller area network bus (CAN bus).

FIG. 1B illustrates the vehicle 100 on a road divided into multiple lanes. As an example, the road shown has four generally parallel lanes, including a left-most lane (defined by lane marker 140 and lane marker 135), a left-interior lane (defined by lane marker 135 and lane marker 130), a right-interior lane (defined by lane marker 130 and lane marker 125) and a right-most lane (defined by lane marker 125 and lane marker 145). However, the concepts herein are applicable to roads with any number of lanes.

The vehicle 100 may include a lane sensor 115 located, for example, within the vehicle interior 102 (e.g., on the backside of a rear-view mirror 120, between the mirror 120 and a windshield). In one embodiment, the lane sensor 115 may be placed on the exterior of the vehicle 100 (e.g., on the hood, grill or near the headlamps). The lane sensor 115, in one embodiment, may be a camera that faces forward (e.g., the same direction that a driver would face when operating the vehicle) and capable of capturing images of the road, and in particular, the lane markers (e.g., lane markers 125, 130, 135, 140 and 145) of the road. The lane sensor 115 may detect the lane markers which define the lane in which the vehicle is traveling (e.g., lane markers 125 and 130) and calculate how close the vehicle 100 is to each of the two lane markers defining the road (e.g., lane markers 125 and 130). In one example, since the lane sensor 115 is at a fixed location, a distance between the lane sensor 115 and the lane markers of the road (e.g., lane markers 125 and 130) may be calculated from data obtained by the lane sensor 115.

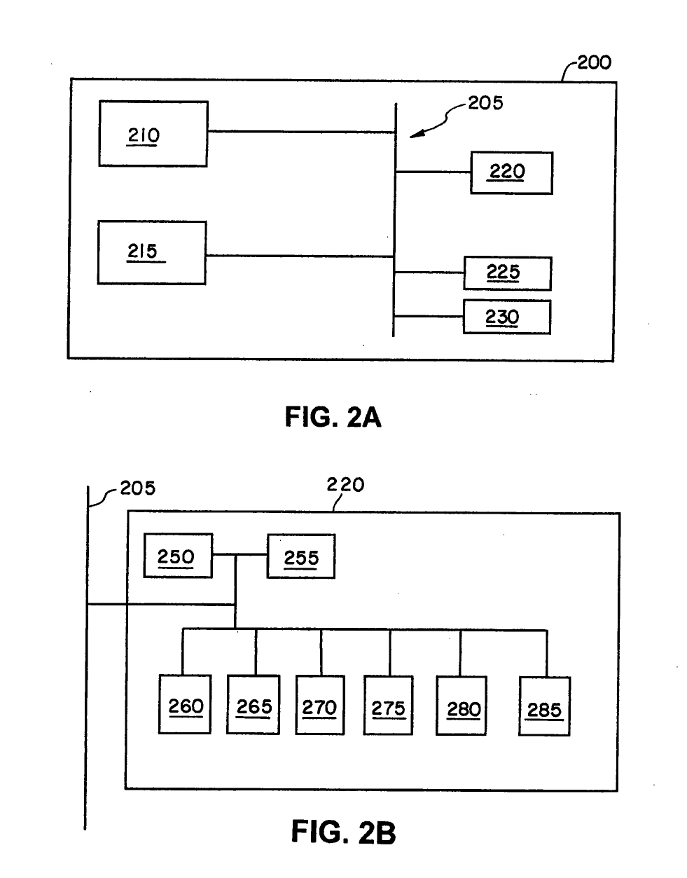

In another example, the lane sensor 115 is a camera which obtains images of the lane markers (e.g., lane markers 125 and 130). Once the image or images are obtained, a distance between the lane markers (e.g., lane markers 125 and 130) and a point of reference (e.g., position of the lane sensor 115) may be calculated by processing the image or images based on, for example, the magnification of the lens, and/or the corresponding size of the other fixed elements captured in the image such as the hood of the vehicle. Image processing may be performed by a processor located within the camera, or performed by a remote image processor, for example, a processor coupled to the vehicle's CAN bus (e.g., processor 250 of FIG. 2B, described below). By calculating the distance to the lane markers from a point of reference (e.g., the location of the lane sensor 115), the vehicle system may determine whether the vehicle 100 is near the center of the lane (and thus considered safely situated) or veering too close to one of the lane markers (e.g., as shown in FIG. 1B, whether the vehicle 100 is moving too close to lane marker 125 or 130).

FIG. 1C illustrates a view of the vehicle interior 102 and the lane markers of the road (e.g., lane markers 125 and 130) through the windshield from the perspective of a driver or a passenger. In this embodiment, the placement of the camera 110 on the steering wheel 105 may be seen in relationship to the lane sensor 115 mounted on the rear view mirror 120. In one embodiment, the camera 110 may be configured to re-position itself if needed, for example, in response to the driver adjusting the position of the steering wheel 105 or the seat. Similarly, the lane sensor 115 may be configured to re-position itself in response to the driver adjusting the position of the rear-view mirror 120. For example, the camera 110 and/or the lane sensor 115 may be pivotably fixed in a housing which allows panning and tilting. In this manner, the camera 110 and the lane sensor 115 may re-position themselves to track the driver's eye and sense the lane markers of the road, respectively.

FIG. 2A is a block diagram illustrating a lane departure warning system 200. As shown, the lane departure warning system 200 may include a CAN bus 205 supporting the data transfer between various vehicle components. For example, a camera 210, a lane sensor 215, a vehicle control unit 220, an audio system control unit 225, and a display control unit 230 may all be coupled to one another via the CAN bus 205. However, other forms of coupling the devices may be used. For example, the camera 210 and the lane sensor 215 may include first and second BLUETOOTH transceivers, respectively, both of which may be in communication with a third BLUETOOTH transceiver coupled to the CAN bus 205.

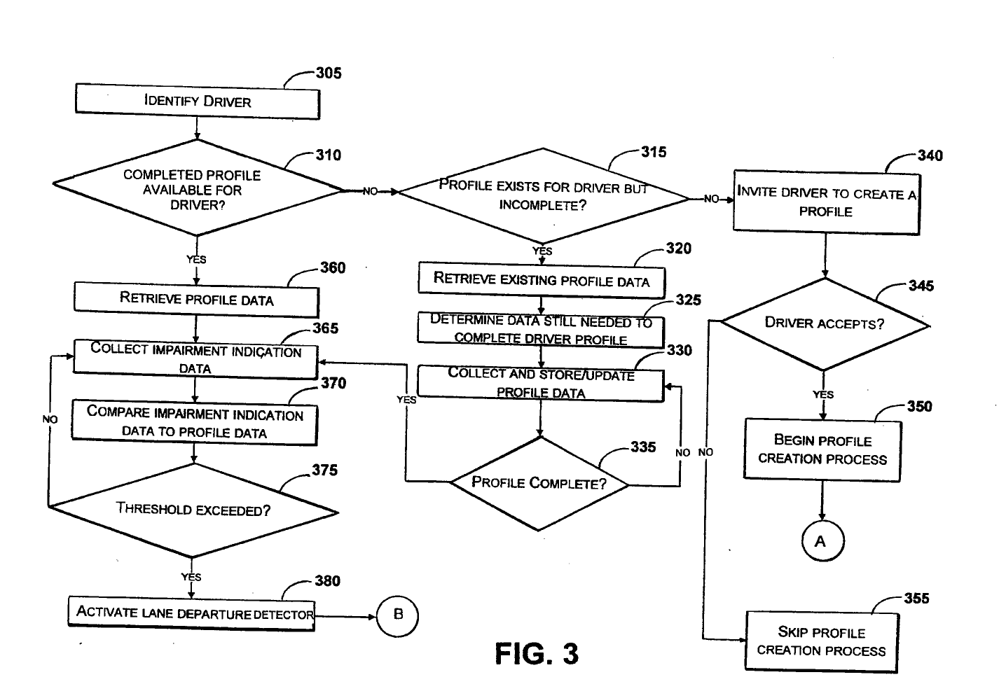

FIG. 2B is a block diagram of a vehicle control unit (e.g., vehicle control unit 220). The vehicle control unit 220 may receive images of a pupil and/or related data (e.g., pupil size) from the camera 210 and may further receive images of the lane markers and/or related data (e.g., distance between the vehicle 100 and a lane marker, for example, lane markers 125-145) from the lane sensor 215. The vehicle control unit 220 may include a processor 250, a memory 255 (e.g., a physical memory such as a hard drive, EEPROM, FLASH, CD-ROM, RAM, DVD, and the like), a pupil comparison module 260, a pupil size measurement module 265, a lane departure determination module 270, a steering data comparison module 275, a braking data comparison module 280 and a transceiver 285. While discussed as separate structural elements in one embodiment, one skilled in the art will understand that the components of the vehicle control unit 220 may be combined and/or integrated into fewer components, and/or separated such that some of these components are located in a separate device (e.g., at the camera 210 or the lane sensor 215). The function of these structural components will be discussed below in connection with FIGS. 3-5.

Turning to FIG. 3, a flow chart of an operation of a lane departure warning system (e.g., lane departure warning system 200, hereafter referred to as “the system 200”) is illustrated. In one embodiment, the system 200 may comprise any and all components described in FIGS. 2A and 2B, among other components. At step 305, the driver may be identified by the system 200. One or more identification methods and systems known in the art may be employed to determine the identity of a driver, such as an identity of the key or a key fob, a biometric sensor, retinal recognition, or other method (e.g., prompting the driver to input a password or select options among a menu of driver names and IDs displayed at the start-up of the vehicle). Once the driver is identified as a known driver, the system 200 may determine whether a completed profile exists for the driver at step 310.

If a completed profile is not available for the driver as determined at step 310, the process moves to step 315 where a distinction between an incomplete profile and a non-existent profile is made by the processor (e.g., the processor 250). If the processor (e.g., the processor 250) determines that the profile is incomplete, the existing profile data is retrieved in step 320. At step 325, the data still needed to complete the profile is determined by the system 200 (e.g., by the processor 250 of the system 200) and as the driver operates the vehicle, the needed data is collected and stored at step 330. At step 335, if the profile is determined to be complete, the system 200 may, in one embodiment, cease to collect information or data for the profile and may begin to obtain data to determine whether the driver may benefit from lane departure assistance (e.g., as shown in FIG. 3 by moving the process along to step 370).

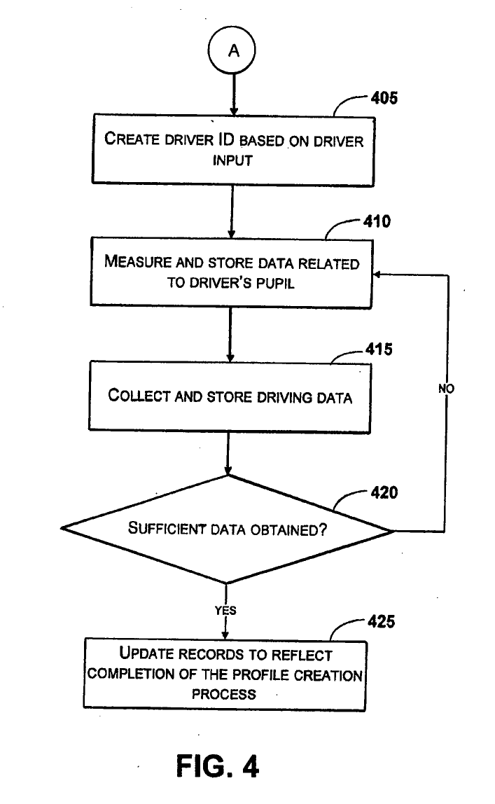

For situations where a profile does not exist as determined by step 315, the system 200 may invite the driver to create a profile at step 340. If the driver accepts the invitation at step 345, the profile creation process begins at step 350, which is more fully described in FIG. 4. However, if the driver declines the invitation at step 345, the profile creation process may be skipped at step 355, and the lane departure detector remains in a deactivated state. In one embodiment, the lane departure detector may be a subsystem of the lane departure warning system 200 and may include, but is not limited to, the processor 250, the memory 255, the lane sensor 215, the audio system control unit 225, the display control unit 230, and the lane departure determination module 270.

Referring back to step 310, if a completed profile exists for the driver, then at step 360, the system 200 may retrieve the driver's profile data from, for example, the memory 225. The profile data may include, among other information, pupil size, average braking force data, steering angle data, and the like. As the vehicle 100 is being operated, current data such as the pupil size of the driver, the average braking force data, or the steering angle data, is collected at step 365. For example, to collect the pupil size of the driver, a camera (e.g., camera 210) may detect and take photos of the driver's eyes and send the image data to the vehicle control unit (e.g., vehicle control unit 220) where the image may be processed to determine the pupil size. In one embodiment, a pupil measuring apparatus (e.g., pupil size measurement module 265) may measure and/or calculate the diameter of a driver's pupil from an image of the eye obtained from the camera (e.g., camera 210). At step 370, the measured or calculated pupil diameter and the pupil diameter saved in the profile may be transmitted to a diameter comparing module (e.g., pupil size comparison module 260) for comparison. At step 375, if the pupil size comparison module 260 determines that a difference in the diameter sizes exceeds a certain threshold, the lane departure detector may be activated at step 380. For example, when the measured or calculated pupil diameter deviates more than 5%, preferably, from the pupil diameter saved in the profile, a processor (e.g., processor 250) may activate the lane departure detector, as the driver is deemed to be impaired or intoxicated and thus, may benefit from the lane departure warnings. While this example uses a 5% deviation, other deviations levels may be implemented, such as 6%, 6.5%, or any value between 0-50%. However, if the system 200 determines that the threshold has not been exceeded in step 375, the process may return to step 365 and the size of the driver's pupil(s) may be collected and analyzed again.

Continuing to analyze the driver's pupil may guard against the scenario where the driver consumes a large amount of alcohol shortly prior to operation of the vehicle 100 such that his or her pupils have not yet fully dilated or otherwise changed in size at the moment the vehicle 100 initially processes the size of the pupil. By repeating the collection and analysis processes, the system 200 is able to take into account any further change in the size of the pupil due to the absorption of alcohol or drugs thereby achieving a more accurate assessment of whether the driver is intoxicated.

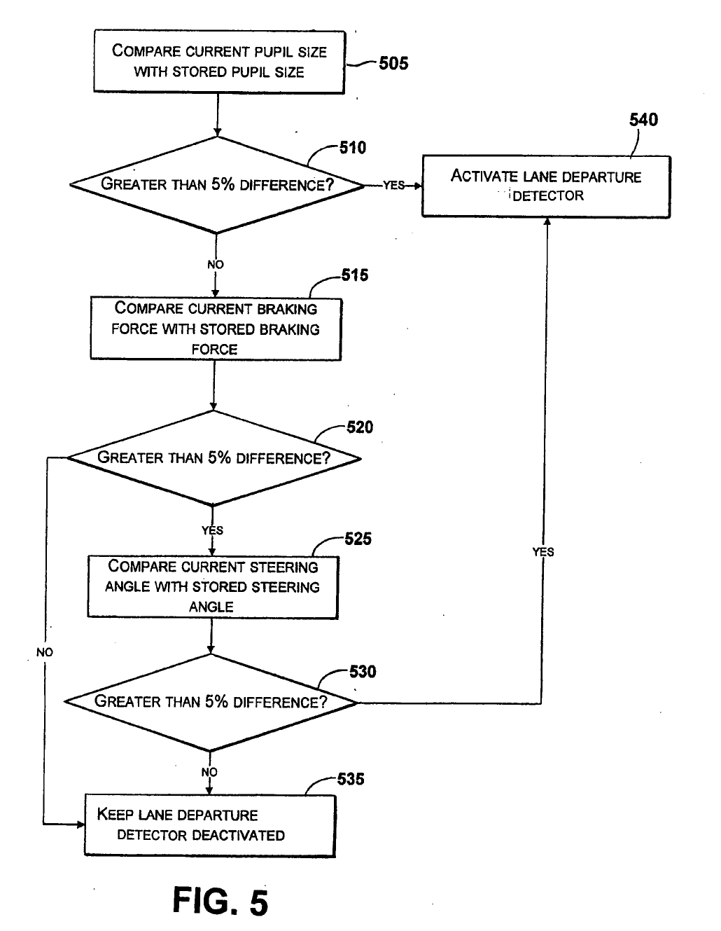

For simplicity, steps 365 and 370 have been described with respect to pupil differences. However, in one embodiment, as further described in FIG. 5, even if the pupil size comparison fails to suggest that the driver is intoxicated, other driving data may be used to infer that the driver is impaired and may benefit from lane departure warnings when the collected data (e.g., steering angles and braking forces) indicate driving patterns outside the norm.

In one embodiment, and in an exercise of caution, once the driver is determined to be legally intoxicated (e.g., the threshold is determined to have been exceeded in step 375), the driver may be deemed intoxicated for the remainder of the driving session (e.g., until the driver shuts off the engine) even if at some point during the driving session the driver recovers from an intoxicated state and returns to a non-intoxicated state.

In one embodiment, the lane departure detector may be deactivated after the system 200 determines that the driver is no longer intoxicated (i.e., by continuously monitoring pupil sizes and if the pupil size returns to a size below the threshold, de-activating the lane departure detector).

In one embodiment, when the driver is above legally allowable thresholds of intoxication, the vehicle 100 may be shut down. For example, the driver may be warned that the engine of vehicle 100 is going to be shut down, and the driver may be given a short amount of time, such as thirty seconds, to move the vehicle 100 over to the shoulder of the road or a parking space. In one embodiment, the vehicle 100 may decrease five mph in speed every thirty seconds to promote a safe driving experience. Contemporaneously, the emergency lights of the vehicle may be activated to alert other drivers on the road. Such an embodiment may be used in conjunction with the other concepts described herein.

FIG. 4 illustrates a flow chart depicting one embodiment of a profile creation process. At step 405, a driver identification is created. The driver identification may be created based on the input of an alphanumeric pass code or via a biometric reading (e.g., fingerprint or voice-print). At step 410, the driver's pupil may be measured and stored as a baseline pupil size. The diameter of the pupil of the driver's right or left eye, or the diameters corresponding to both pupils of the driver's eyes may be measured. At step 415, statistical data of the driver's driving tendencies may be collected as the driver operates the vehicle 100. For example, the processor 250 may measure the speed of the vehicle 100 and steering force applied as the vehicle 100 makes turns. The processor 250 may store in the memory 255 data related to how “hard” or “soft” the driver typically makes turns on the road. For example, some drivers may slow the vehicle 100 to almost a complete stop before making a turn, while other drivers may aggressively steer the vehicle 100 when approaching a turn which may result in sharper turns. Such data may be taken over a span of tens or hundreds of miles to establish the tendencies of a driver.

In another example, braking force may be measured each time the vehicle 100 decelerates. Obtaining samples of braking force applied yields a more comprehensive picture of how the driver typically utilizes the brakes in operating the vehicle 100. Certain drivers may ease into the brakes and slow the vehicle 100 over a longer period of time and/or distance, while other drivers may consistently wait and slam on the brakes closer to when braking of the vehicle 100 is absolutely needed to prevent an accident. These tendencies may be determined by collecting samples over a substantial period of driving time and may be used, in one embodiment, to assist in ascertaining whether the driver is impaired.

Other examples of driving data collected may include the time of day the vehicle 100 is being operated by the driver, the average speed of the vehicle 100, and the like. More particularly, the time of day the vehicle 100 is being operated may be correlated with other data collected such as braking force applied and steering angle data to assist in determining whether the driver is impaired. For example, if a driver tends to drive more carefully (e.g., longer braking spans, lower vehicle speeds, etc.) late at night compared to the daytime, such factors may be taken into account when determining whether the driver is impaired.

Referring back to FIG. 4, once sufficient data is obtained by the system 200 at step 420, the profile creation process is completed and the profile is marked as such at step 425. By completing the profile, the next time the driver operates the vehicle 100, the system 200 may collect impairment indication data (e.g., in one embodiment, the same data collected to establish the profile) and compare the impairment indication data to the profile data to determine whether the driver is intoxicated.

FIG. 5 illustrates one example of determining whether the driver is impaired by using the collected impairment indication data. At step 505, the currently measured pupil size may be compared with the pupil size data stored in the memory 225. In one example, the pupil size data collected and compared may be of one eye or both eyes. At step 510, the system 200 determines if the difference between the pupil size of the currently measured pupil and the stored pupil data exceeds 5%. In one embodiment, where both pupils of the driver is measured, each pupil may need to be 5% longer or shorter than the respectively stored pupil sizes before the process moves to step 540. If the pupil size fails to exceed the threshold as determined in step 510, the process moves to step 515, where the braking force (e.g., average braking force of the current driving session) is compared to the stored braking force data (e.g., average braking force recorded in the profile data). In one example, the braking data comparison module 280 may receive data from the memory 225 regarding the average braking force stored for the profile and may receive data from the processor 250 regarding the average braking force of the current driving session. The braking data comparison module 280 may compare the two average values to determine whether a greater than 5% difference exists between the two values at step 520. If so, the process may move to step 525 where the current steering angle data (e.g., average steering angle for turns and/or curves of the current driving session) is compared to the stored steering data (e.g., average steering angle for turns and/or curves recorded in the profile data). In one example, the steering data comparison module 275 may receive data from memory 255 regarding the average steering angle stored for the profile and may receive data from the processor 250 regarding the steering angle of the current driving session. The steering data comparison module 275 may then compare the two average values to determine whether a greater than 5% difference exists between the two values at step 530. If the result is affirmative, the lane departure detector may be activated at step 540; otherwise the lane departure detector remains deactivated.

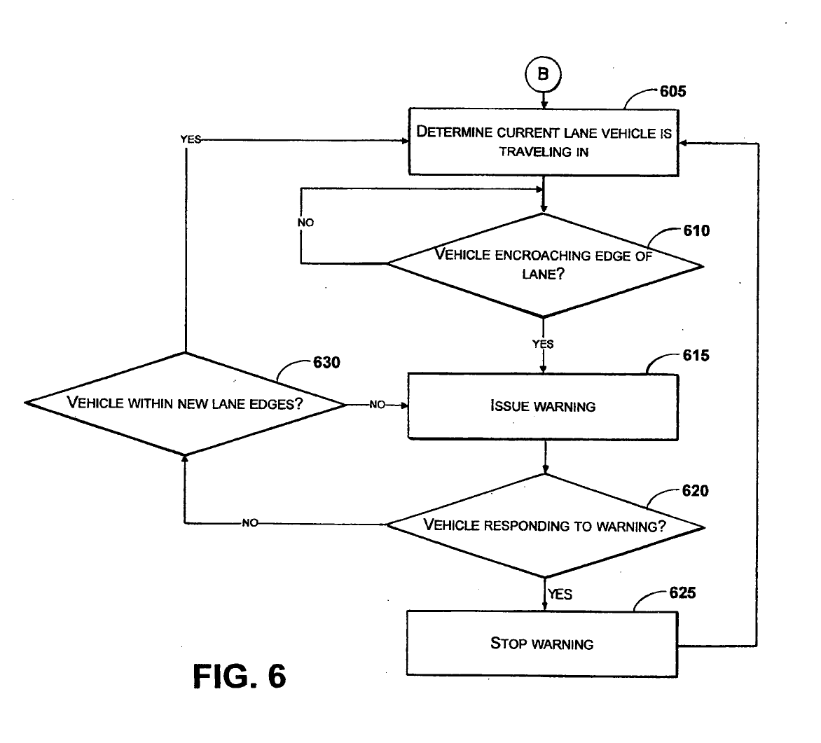

Once the lane departure detector is activated, the driver may be warned each time the vehicle veers too close to the lane markers of the current lane in which the vehicle is traveling. FIG. 6 is a flow chart of the operation of the lane departure detector. As discussed above, in one embodiment, the lane departure detector may be a subsystem of the lane departure warning system 200. One skilled in the art will appreciate that other processors, memories, and the like may be further included and/or dedicated to performing certain steps of the lane departure detector.

At step 605, the lane departure detector determines the current lane that the vehicle is traveling in, for example, by using lane sensors (e.g., lane sensor 215) to ascertain the lane markers to the left and the right of the vehicle 100, respectively. Once the lane markers are determined, the lane departure determination module 270 may calculate a distance between the tire of the vehicle 100 closest to the lane marker and the lane marker itself. At step 610, the lane departure determination module 270 may ascertain whether the vehicle 100 is encroaching on the edge of the lane based on the calculated distance alone or in combination with other factors. Other factors that may be taken into account include, for example, whether the vehicle 100 is turning on a curved portion of a road (e.g., the lane departure determination module 270 may allow the vehicle 100 to encroach closer to the edge of the lane before triggering a warning than if the vehicle 100 were on a straight portion of the lane), the speed of the vehicle 100 (e.g., at lower speeds, the lane departure determination module 270 may allow the vehicle 100 to encroach closer to the edge of the lane before triggering a warning), the width of the lane (e.g., with a narrower lane, the lane departure determination module 270 may allow the vehicle 100 to encroach closer to the edge of the lane before triggering a warning), time of day (daytime vs. night time), weather (e.g., cold, icy conditions as opposed to a clear, sunny day), among other factors. The lane departure determination module 270 may continue to monitor whether the vehicle 100 is too close to either one of the two closest lane markers (e.g., lane markers 125 and 130 of FIG. 1B). Once the lane departure determination module (e.g., a lane departure determination module 270) determines that the vehicle 100 is encroaching too closely to the lane marker (e.g., lane markers 125 and 130 of FIG. 1B) at step 610, a warning may be issued to the driver through the audio and/or display systems (e.g., audio and display system 225 and 230) of the vehicle 100 at step 615. Typically for non-intoxicated drivers, a warning system may warn the driver when the vehicle 100 actually crosses the lane marker (e.g., lane markers 125 and 130 of FIG. 1B) as to avoid overly annoying the driver each time the driver moves too close to the lane markers (e.g., lane markers 125 and 130 of FIG. 1B).

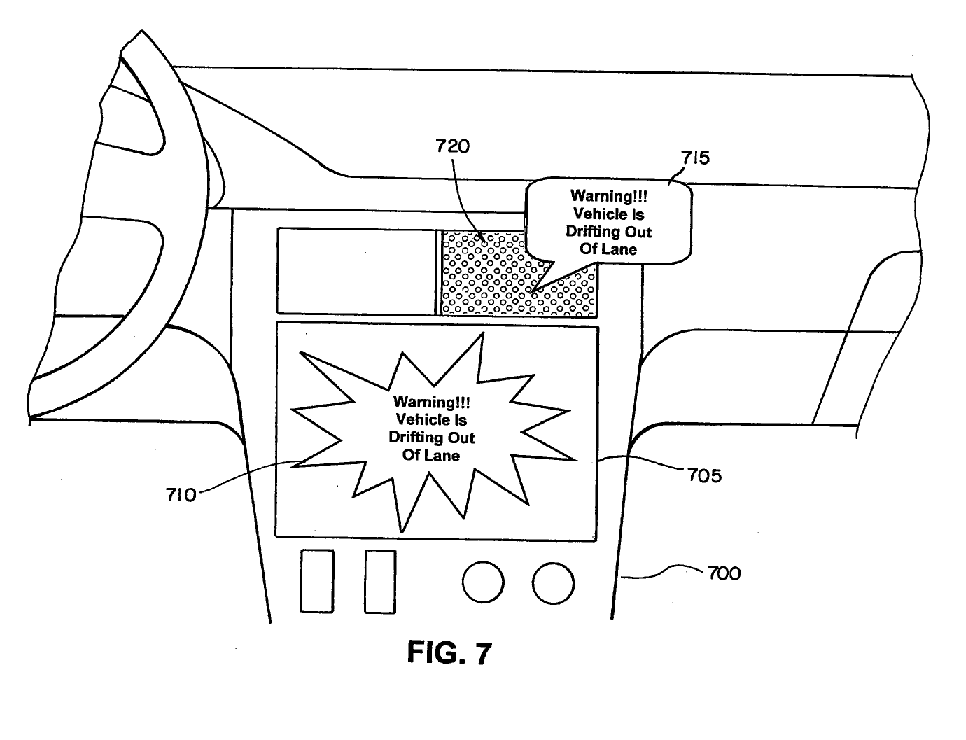

FIG. 7 illustrates an example of a visual and/or audio warning. The center console 700 for a vehicle 100 may include a display 705 and speakers 720. The warning message 710 may be displayed, and the same warning message 715 may be audibly played either simultaneously or contemporaneous to each other. The displayed warning message 710 may flash, change colors, use large fonts, and/or otherwise convey the warning 710 to the driver in an effective manner. Alternatively, the driver may configure the system to issue warnings (e.g., warning 710 or 715) via only one of the two outputs (e.g., the speakers 720 or the display 710).

With respect to the audible warning 715 issued through the speakers 720, other examples of warning sounds may include, for example, a noise normally heard when a vehicle drives over a rumble strip (e.g., a periodic “rumble” sound). In one embodiment, the speaker closest to the lane marker encroached may be utilized to output the sound to provide the driver a directional sound so the driver may easily ascertain which lane marker the vehicle 100 is encroaching (not shown). In one embodiment, the warning message or sound (e.g., warning 710 or 715) may have priority over any audible message currently being played through the speaker 720 (e.g., songs on the radio or from the CD player, navigation commands from a GPS, and the like). Furthermore, the decibel level for the message may be preset such that even if the current decibel output level of the speaker 720 is higher or lower than the preset level for the message, the speaker 720 may automatically adjust to the preset decibel level for the message for outputting of the message, before returning to the previous decibel level.

Turning back to FIG. 6, after the warning (e.g., warning 710 or 715) is issued in step 615, if the vehicle 100 responds to the warning (e.g., warning 710 or 715) at step 620 (e.g., by moving back towards the center of the lane), the warning (e.g., warning 710 or 715) may be stopped in step 625. However, if the vehicle 100 fails to respond to the warning (e.g., warning 710 or 715), at step 630, the lane departure determination module 270 may determine whether the vehicle 100 is within new lane markers. If not, the warning (e.g., warning 710 or 715) may continue to be outputted. However, if the vehicle 100 is determined to be in a new lane, the process reverts back to step 605.

In one embodiment, the processor 250 may, before step 615, perform an additional step of checking the activation of the turn signal before issuing the warning (e.g., warning 710 or 715). If the turn signal is activated, the warning (e.g., warning 710 or 715) might not be given since it is likely that the driver actually intends to exit the current lane and hence, the vehicle 100 would necessarily encroach and cross over the lane marker.

Those of ordinary skill would appreciate that the various illustrative logical blocks, modules, and algorithm steps described in connection with the examples disclosed herein may be implemented as electronic hardware, computer software, or combinations of both. Furthermore, the present invention can also be embodied on a machine readable medium causing a processor or computer to perform or execute certain functions.

To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the disclosed apparatus and methods.

The various illustrative logical blocks, units, modules, and circuits described in connection with the examples disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the examples disclosed herein may be embodied directly in hardware, in a software module executed by a processor, or in a combination of the two. The steps of the method or algorithm may also be performed in an alternate order from those provided in the examples. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an Application Specific Integrated Circuit (ASIC). The ASIC may reside in a wireless modem. In the alternative, the processor and the storage medium may reside as discrete components in the wireless modem.

The previous description of the disclosed examples is provided to enable any person of ordinary skill in the art to make or use the disclosed methods and apparatus. Various modifications to these examples will be readily apparent to those skilled in the art, and the principles defined herein may be applied to other examples without departing from the spirit or scope of the disclosed method and apparatus. The described embodiments are to be considered in all respects only as illustrative and not restrictive and the scope of the invention is, therefore, indicated by the appended claims rather than by the foregoing description. All changes which come within the meaning and range of equivalency of the claims are to be embraced within their scope.

What is claimed is:

1. A method comprising:
identifying a driver of a vehicle;
determining that a completed profile is available corresponding to the driver;
retrieving the completed profile from a corresponding vehicle memory;
collecting impairment indication data including a size of a pupil of the driver;
comparing impairment indication data to the data corresponding to the retrieved completed profile;
determining, based on the comparison of the impairment indication data to data corresponding to the completed profile, that the driver is to be treated as an impaired driver;
activating a lane departure detector; and
outputting a warning when the vehicle is encroaching an edge of the lane of a road.

2. The method of claim 1 further comprising:
in response to identifying the driver as a new driver, inviting the driver to create a profile;
in response to receiving input that the driver accepts the invitation to create a new profile, creating a driver identification profile;
collect and store data related to the driver's pupil; and
collect and store data related to the driver's operation of the vehicle.

3. The method of claim 1 further comprising:
in response to identifying the driver as a known driver with an incomplete profile, retrieving existing profile data corresponding to the incomplete profile from the vehicle memory;
determine data needed to complete the incomplete profile; and
collect and store the needed data to complete the incomplete profile.

4. The method of claim 1 further comprising stopping output of the warning when the vehicle moves away from the encroached edge of the lane of the road, and wherein outputting a warning includes one of: displaying on a vehicle display a message indicating that the vehicle is encroaching an edge of the lane of the road, or playing an audible message indicating that the vehicle is encroaching an edge of the lane of the road.

5. The method of claim 1 wherein activating the lane departure detector further comprises:
identifying a point of reference corresponding to the vehicle;
identifying a point of reference corresponding to a first lane marker;
identifying a point of reference corresponding to a second, adjacent lane maker;
calculating a first distance between the point of reference corresponding to the vehicle and the first lane marker;
calculating a second distance between the point of reference corresponding to the vehicle and the point of reference corresponding to the second, adjacent lane marker; and
determining that the vehicle is encroaching the edge of the lane of a road when one of the first distance and second distance exceeds a threshold.

6. The method of claim 5 wherein identifying a point of reference corresponding to the first lane marker is performed by a camera and wherein identifying a point of reference corresponding to the second, adjacent lane marker is performed by a camera.

7. The method of claim 5 wherein activating the lane departure warning system occurs in response to determining that the driver is to be treated as an impaired driver.

8. The method of claim 1 wherein impairment indication data further comprises braking data and steering data.

9. The method of claim 8 wherein determining that the driver is to be treated as an impaired driver includes at least one of:
determining that the size of the pupil of the driver corresponding to the impairment indication data is different than the size of the pupil of the driver corresponding to the completed profile;
determining that the braking data of the impairment indication data is different than the braking data corresponding to the completed profile; and
determining that the steering data of the impairment indication data is different than the steering data corresponding to the completed profile.

10. The method of claim 9 wherein determining that the driver is to be treated as an impaired driver further comprises determining that the diameter of the pupil of the driver corresponding to the impairment indication data is at least 5% longer or 5% shorter than the diameter of the pupil of the driver corresponding to the completed profile.

11. The method of claim 9 wherein determining that the driver is to be treated as an impaired driver further comprises:
determining that the diameter of the pupil of the driver corresponding to the impairment indication data does not exceed either 5% longer or 5% shorter than the diameter of the pupil of the driver corresponding to the completed profile, and that an average braking force applied to a set of vehicle brakes corresponding to the impairment indication data is at least 5% greater or 5% less than an average braking force corresponding to the completed profile, and that an average steering angle of the vehicle corresponding to the impairment indication data is at least 5% greater or 5% less than an average steering angle of the vehicle corresponding to the completed profile.

12. The method of claim 1 wherein the size of a pupil of the driver corresponding to the completed profile is obtained during a driving session different than the driving session of which the size of the pupil of the driver corresponding to the impairment indication data is collected.

13. The method of claim 12 wherein obtaining the size of the pupil of the driver corresponding to the completed profile and collecting the size of the pupil of the driver corresponding to the impairment indication data is performed in part by a camera located within an interior of the vehicle.

14. A device comprising:
a processor;
a memory coupled to the processor;
an image processing module coupled to the processor and configured to process an image to determine pupil size;
a pupil comparator configured to receive the pupil size of the image and compare the pupil size of the image to a pupil size of a user's profile stored in the memory, the pupil comparator further configured to output a result of the pupil size comparison; and
a determination module configured to receive the result of the pupil comparison and determine if the result of the pupil size comparison exceeds a pupil difference threshold,
wherein the processor is configured to trigger activation of a lane departure detector when the result of the pupil size comparison exceeds the pupil difference threshold.

15. The device of claim 14 further comprising:
a steering behavior comparator configured to receive the current steering behavior data and compare the current steering behavior data to a baseline steering behavior data stored in the memory, the steering behavior comparator further configured to output a result of the steering behavior comparison; and
a braking data comparator configured to receive the current braking data and compare the current braking data to a baseline braking data stored in the memory, the braking data comparator further configured to output a result of the braking data comparison;
wherein the determination module is further configured to receive the result of the steering behavior comparison from the steering behavior comparator and the result of the braking data comparison from the braking data comparator, the determination module further configured to determine whether the result of the steering behavior comparison exceeds a steering threshold and whether the result of the braking data comparison exceeds a braking threshold,
wherein the processor is further configured to trigger activation of the lane departure detector when both the result of the steering behavior comparison exceeds the steering threshold and the result of the braking data comparison exceeds the braking threshold.

16. The device of claim 14 further comprising:
a lane marker encroachment module configured to be activated in response to receiving a lane departure detector activation signal from the processor, the lane marker encroachment module configured to determine whether a lane of road that that a vehicle is traveling in based on a pair of lane markers, and to determine when a distance between the vehicle and one of the lane markers is shorter than a encroachment threshold, the lane marker encroachment module further configured to output a warning signal when the distance between the vehicle and one of the lane markers is shorter than a encroachment threshold.

17. A system comprising:
a camera configured to capture an image of a driver's pupil;
a sensor configured to determine a distance between a lane marker and a vehicle; and
a vehicle control unit configured to receive an image of the driver's pupil and the distance between the lane marker and the vehicle, the vehicle control unit configured to determine if the driver is impaired based at least in part on the image of the driver's pupil, the vehicle control unit configured to determine if a vehicle is encroaching on the lane marker based a distance between the lane marker and the vehicle, the vehicle control unit further configured to output a warning signal when the driver is impaired and the vehicle is encroaching on the lane marker.

18. The system of claim 17 further comprising an audio control unit configured to receive the warning signal from the vehicle control unit and output an audio message.

19. The system of claim 17 further comprising a display control unit configured to receive the warning signal from the vehicle control unit and output a visual message.

20. The system of claim 17 wherein the vehicle control unit is further configured to determine if the driver is impaired based on steering behavior and braking data.
